(19) United States
(12) Patent Application Publication
(10) Pub. No.: US 2026/0105499 A1
(43) Pub. Date: Apr. 16, 2026

(54) SYSTEM AND METHOD FOR MULTI-USER CONCURRENT TRAVEL

(71) Applicants: Steven Milosevich, Trumbull, CT (US); David DeBaise, Wallingford, CT (US)

(72) Inventors: Steven Milosevich, Trumbull, CT (US); David DeBaise, Wallingford, CT (US)

(21) Appl. No.: 18/911,291

(22) Filed: Oct. 10, 2024

(51) Int. Cl. G06Q 30/0283; G06Q 10/02

(52) U.S. Cl. CPC G06Q 30/0283; G06Q 10/02

(57) ABSTRACT

A method comprises receiving, via at least one processor, a first input from one or more users; generating, via the at least one processor, at least one request for sending simultaneously to a plurality of global distribution units (GDUs) based at least on the first input received; receiving, via the at least one processor, information from each of GDUs for each of one or more participants selected; filtering, via the at least one processor, information for creating one or more itineraries for each of one or more participants, using an artificial intelligence (AI)/machine learning (ML) model, displaying, via the at least one processor, created one or more itineraries for each of one or more participants to user: determining, via the at least one processor, a second input received from user; and calculating, via the at least one processor, the pricing information for each of one or more itineraries.

### FIELD OF THE DISCLOSURE

The present invention relates to data processing technology, data analysis technology and travel planning technology. More particularly, the invention relates to a system and method for multi-user concurrent travel.

### BACKGROUND OF THE DISCLOSURE

Individuals are inundated with a wealth of information, due in part to advances in the Internet and the increasing popularity of different types of social media available to the individuals. In addition, work-related responsibilities and personal engagements generate their own sources of information that overload the individuals. For example, making travel arrangements can be a complex task depending on factors such as the number of travel-related resources involved in the planning such as, connecting flights, vehicle rentals, lodging etc., or the number of travelers in a group for which the trip is planned. Further, coordinating the travel plans for a group of travelers generally involves manual entry of each participant's name and personal information into a reservation system that is necessary to secure a booking. When a future trip is planned, the same manual entry is generally required. Similar issues are known to other responsibilities of individuals, such as work-related and personal tasks. Further, there is no provision of accessing information for the trip, including back timing travel times, so that the individuals know when to depart by considering traffic or travel delays to the event, event times and locations, food etc.

Prior art, for various aspects contained there within, relevant to this disclosure includes US patent application No. 20230027411A1 of Jafri Vajid, EP patent application No. 2416285A1 of Keagul Mary, US patent application No. 20230306538A1 of Stableford Warren and includes website “govamos.io”. In each of the prior art references, a travel booking system is disclosed. Inspection of the prior arts reveals approaches that are not ideal solutions for providing access to all information for a trip, including back travel times.

In particular, reference 411′ of Vajid describes a travel distribution system. The travel distribution system can include searching for flights for airlines using new distribution capability (NDC) standards, global distribution system (GDS) network, or using an application program interface (API) or websites. Artificial intelligence can also be used to assist the search for best matching a customer's travel preference profile. In the prior art, the searches can be performed simultaneously in parallel. For example, a search request can be sent for airlines using NDC standards, immediately followed by a search request for airlines using API protocols or websites, and immediately followed by a search request for airlines using GDS network. However, unlike the subject matter of the disclosed invention, the travel distribution system does not provide a real time budget means to recalculate an individual person's budget, group budget, and budgets for flights, hotels, and ground, in a scenario whenever the planner or user selects other choices in case they need to change from the recommended choices based on their preferences. In addition, the travel distribution system does not suggest that once all the things get purchased, and the event information is in, the user can access all the information for their trip, including back timing travel times, so that the user knows when to depart by considering traffic or travel delays to the event, event times and locations, food etc.

In particular, reference 285′ of Mary describes a method for searching for a travel product having one or more data elements associated therewith from a plurality of potentially suitable travel products in a system. The system comprises a web based interface for receiving inputs from a user and from one or more sources of data, and for displaying results to a user based on the inputs; a business logic layer providing access to the sources of data in a predetermined manner, such as based on rules and preferences; and a database including data relating to the parties associated with the system. The reference further comprises the method having the steps of entering one or more search parameters into the interface; launching multiple simultaneous searches based on the search criteria and one or more attribute of the travel product to the one or more sources of data to identify the potentially suitable travel products; displaying the potentially suitable travel products on the interface; selecting one or more of the potentially suitable travel products for further processing; further processing the potentially suitable travel products by normalizing the data elements associated with the potentially suitable travel products into a homogeneous display; determining a combination of data elements of the one or more potentially suitable travel products which in combination are the most suitable travel products for a customer based on customer preferences and attributes. However, unlike the subject matter of the disclosed invention, the method does not suggest that once all the things get purchased, and the event information is in, the user can access all the information for their trip, including back timing travel times, so that the user knows when to depart by considering traffic or travel delays to the event, event times and locations, food etc. Also, the method does not suggest that when the reservation gets placed, be it a hold or purchase, the trip prices are recalculated as prices change based on availability.

In particular, reference 538′ of Warren describes systems and methods for processing changes to travel itineraries. A system can comprise a database, a scheduler, and an optimizer. The database stores travel itineraries, traveler preferences, and itinerary change parameters. The scheduler exchanges information with travel supply networks and is operable to receive a travel itinerary, receive related travel itineraries, and optionally search the database for the related travel itineraries. The optimizer is operable to evaluate travel itinerary change tolerance parameters associated with the travel itinerary based on the traveler preferences, the itinerary change parameters, and the related travel itineraries; generate an optimized set of itinerary change tolerance parameters based on the evaluated itinerary change tolerance parameters and an optimization goal and store the optimized set of itinerary change tolerance parameters for updating the travel itinerary. However, unlike the subject matter of the disclosed invention, the system does not provide, among other things such as, a real time budget means to recalculate the individual person's budget, group budget, and budgets for flights, hotels, and ground, in a scenario whenever the planner or user selects other choices in case they need to change from the recommended choices based on their preferences. In addition, the system does not suggest that once all the things get purchased, and the event information is in, the user can access all the information for their trip, including back timing travel times, so that the user knows when to depart by considering traffic or travel delays to the event, event times and locations, food etc.

In particular, reference “govamos.io” is a corporate travel platform designed for distributed teams that streamlines group booking to bring people together. This platform uses a unique machine-learning algorithm to recommend the perfect city, hotels, and activities tailored to company and individual preferences. As teams use the platform, it gathers data on users'preferences, enabling seamless trip planning and booking with a single click. However, the platform does not provide recalculation of the individual person's budget, group budget, and budgets for flights, hotels, and ground, in a scenario whenever the planner or user selects other choices in case they need to change from the recommended choices based on their preferences. In addition, the platform also does not calculate back timing travel times and is not able to evaluate current situation of the user and reiterate the schedule such that travel information based on the current situation so that the user reaches its destination on time.

Therefore, there is a need for an improved multi-user concurrent travel that may provide access to all the information for a trip, including back timing travel times, so that a user knows when to depart by considering traffic or travel delays to the event, event times and locations, food etc.

### SUMMARY OF THE DISCLOSURE

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In one example embodiment, a method is disclosed. The method comprises receiving, via at least one processor, a first input from one or more users. The first input corresponds to a selection of at least one event from one or more events by the one or more users and a selection of one or more participants by the one or more users. Further, the method comprises generating, via the at least one processor, at least one request for sending simultaneously to a plurality of global distribution units (GDUs) based at least on the first input received. The at least one request corresponds to a query for retrieving data from the plurality of GDUs corresponding to the received first input. Further, the method comprises receiving, via the at least one processor, information from each of the GDUs for each of the one or more participants selected. The information comprises at least one of flight details, hotel details, event ticket details, and ground transportation details. Further, the method comprises filtering, via the at least one processor, the information for creating one or more itineraries for each of the one or more participants selected, using an artificial intelligence (AI)/machine learning (ML) model. The one or more itineraries comprise at least one of pricing information and back timing travel information. Further, the method comprises displaying, via the at least one processor, the created one or more itineraries for each of the one or more participants to the one or more users. Further, the method comprises determining, via the at least one processor, a second input received from the one or more users. The second input corresponds to accepting, holding, or changing the one or more itineraries for the one or more participants. Thereafter, the method comprises calculating, via the at least one processor, the pricing information for each of the one or more itineraries based on a determination of the second input.

In some embodiments, the method further comprising training, via the at least one processor, the AI/ML model based at least on the received information from each of the GDUs, real time traffic conditions, weather details, participant data, first input, second input, historical data, and event information.

In some embodiments, the method further comprising determining, via the at least one processor, a current location of the one or more participants using a ground positioning unit (GPU) in real-time; determining, via the at least one processor, whether the one or more participants reach on time for the at least one event; and predicting, via the at least one processor, one or more travel routes and transportation for the one or more participants to reach on time for the at least one event using the trained AI/ML model upon determining that the one or more participants are not able to reach on time for the at least one event.

In some embodiments, the method further comprising predicting, via the at least one processor, pricing information for each of the predicted one or more travel routes and transportation for the one or more participants in real-time using the trained AI/ML model; and suggesting, via the at least one processor, the predicted one or more travel routes and transportation to the one or more participants using the trained AI/ML model based at least on the predicted pricing information.

In some embodiments, the method further comprising updating, via the at least one processor, the one or more itineraries based on the calculated pricing information or the predicted pricing information for each of the one or more participants in real-time using the trained AI/ML model; and transmitting, via the at least one processor, the updated one or more itineraries to the one or more participants and/or the one or more users.

In some embodiments, the method further comprising retrieving, via the at least one processor, the event information from an event database and the participant data from one or more users database based at least on the received input.

In some embodiments, the event information comprises at least one of name, location, date, priority, and duration of each of the one or more events, wherein the participant data comprise at least one of name, date of birth, location of residence, flight preferences, hotel preferences, vehicle preferences, requirement of ground transportation, requirement of hotel, and budget of each of the one or more participants.

In some embodiments, the plurality of GDUs correspond to a network system that maintains a centralized database having aggregated data of the flight details, hotel details, event ticket details, and ground transportation details, wherein the plurality of GDUs correspond to at least a flight GDU, a hotel GDU, a ground transportation GDU, and an event ticket GDU.

In some embodiments, the one or more itineraries comprise at least one of filtered flight details, hotel details, event ticket details, and ground transportation details for each of the one or more participants, and wherein the back timing travel information comprises desired arrival time, total travel time, start time, and stop time of the one or more participants for the one or more events.

In some embodiments, the method further comprising, displaying, via the at least one processor, payment options associated with the pricing information for the one or more users and for each of the one or more participants, to the one or more users, and wherein the pricing information comprises budget of each of the one or more participants, a group budget, and budgets for flights, hotels, and ground transportation.

In another example embodiment, a system is disclosed. The system comprises at least one processor that is configured to receive a first input from one or more users. The first input corresponds to a selection of at least one event from one or more events by the one or more users and a selection of one or more participants by the one or more users. Further, the at least one processor is configured to generate at least one request for sending simultaneously to a plurality of global distribution units (GDUs) based at least on the received input. The at least one request corresponds to a query for retrieving data from the plurality of GDUs corresponding to the received input. Furthermore, the at least one processor is configured to receive information from each of the GDUs for each of the one or more participants selected. The information comprises at least one of flight details, hotel details, event ticket details, and ground transportation details. Further, the at least one processor is configured to filter the information for creating one or more itineraries for each of the one or more participants selected, using an artificial intelligence (AI)/machine learning (ML) model. The one or more itineraries comprise at least one of pricing information and back timing travel information. Furthermore, the at least one processor is configured to display the created one or more itineraries for each of the one or more participants to the one or more users. Further, the at least one processor is configured to determine a second input received from the one or more users. The second input corresponds to accepting, holding, or changing the one or more itineraries for the one or more participants. Thereafter, the at least one processor is configured to calculate the pricing information for each of the one or more itineraries based at least on the determination.

In another example embodiment, a non-transitory machine-readable information storage medium is disclosed. The non-transitory machine-readable information storage medium comprising one or more instructions which when executed by at least one processor cause the at least one processor to receive a first input from one or more users, wherein the first input corresponds to a selection of at least one event from one or more events by the one or more users and a selection of one or more participants by the one or more users; generate at least one request for sending simultaneously to a plurality of global distribution units (GDUs) based at least on the received input, wherein the at least one request corresponds to a query for retrieving data from the plurality of GDUs corresponding to the received input; receive information from each of the GDUs for each of the one or more participants selected, wherein the information comprises at least one of flight details, hotel details, event ticket details, and ground transportation details; filter the information for creating one or more itineraries for each of the one or more participants selected, using an artificial intelligence (AI)/machine learning (ML) model, wherein the one or more itineraries comprise at least one of pricing information and back timing travel information; display the created one or more itineraries for each of the one or more participants to the one or more users; determine a second input received from the one or more users, wherein the second input corresponds to accepting, holding, or changing the one or more itineraries for the one or more participants; and calculate the pricing information for each of the one or more itineraries based at least on the determination.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a network diagram of a system for multi-user concurrent travel in accordance with an example embodiment of the present disclosure;

FIG. 2 illustrates a block diagram of a server in accordance with an example embodiment of the present disclosure;

FIGS. 3A-3B illustrate a system flowchart for multi-user concurrent travel in accordance with an example embodiment of the present disclosure;

FIG. 4 illustrates a user interface (UI) showing selection of at least one event in accordance with an example embodiment of the present disclosure;

FIG. 5 illustrates a UI showing list of participants in accordance with an example embodiment of the present disclosure;

FIG. 6 illustrates a UI showing list of participants selected in accordance with an example embodiment of the present disclosure;

FIG. 7 illustrates a UI showing total budget details in accordance with an example embodiment of the present disclosure;

FIG. 8 illustrates a UI showing itinerary details in accordance with an example embodiment of the present disclosure;

FIG. 9 illustrates a UI showing hotel options in accordance with an example embodiment of the present disclosure; and

FIG. 10 illustrates a flowchart showing a method for multi-user concurrent travel in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. As discussed herein, the protection devices may be referred to use by humans, but may also be used to raise and lower objects unless otherwise noted.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

The present disclosure provides various embodiments of methods and systems for multi-user concurrent travel. Embodiments may be configured to be executed by at least one processor for receiving a first input from one or more users. The first input may correspond to a selection of at least one event from one or more events by the one or more users and a selection of one or more participants by the one or more users. Embodiments may be configured to generate at least one request for sending simultaneously to a plurality of global distribution units (GDUs) based at least on the first input received. The at least one request may correspond to a query for retrieving data from the plurality of GDUs corresponding to the received input. Embodiments may be configured to receive information from each of the GDUs for each of the one or more participants selected. The information may comprise at least one of flight details, hotel details, event ticket details, and ground transportation details.

Embodiments may be configured to filter the information for creating one or more itineraries for each of the one or more participants selected, using an artificial intelligence (AI)/machine learning (ML) model. The one or more itineraries may comprise at least one of pricing information and back timing travel information. Embodiments may be configured to display the created one or more itineraries for each of the one or more participants to the one or more users. Embodiments may be configured to determine a second input received from the one or more users. The second input may correspond to accepting, holding, or changing the one or more itineraries for the one or more participants. Embodiments may be configured to calculate the pricing information for each of the one or more itineraries based at least on the determination.

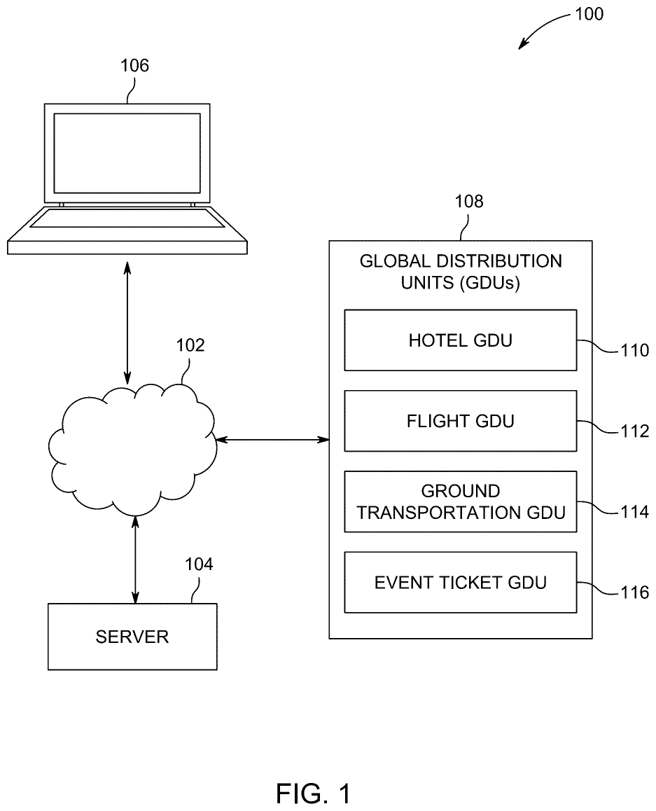

FIG. 1 illustrates a network diagram of a system 100 for multi-user concurrent travel, in accordance with an example embodiment of the present disclosure. The system 100 may comprise a network 102 communicatively coupled to a server 104, a user device 106, and a plurality of global distribution units (GDUs) 108. Further, the plurality of GDUs 108 may comprise a hotel GDU 110, a flight GDU 112, a ground transportation GDU 114, and an event ticket GDU 116.

In some embodiments, the network 102 may be a communication network such as Internet or a cloud network, that may be configured to allow computing devices and processing systems to communicate with each other through wired network, wireless network, or a combination of both. In some embodiments, the network 102 may refer to as a distributed infrastructure that is configured to exchange of data, information, and resources among interconnected computing devices and systems. The network 102 may be designed to facilitate communication and collaboration across various locations, devices, and platforms. Those skilled in the art will recognize that wired devices may include, but are not limited to, wired networks such as Wide Area Networks (WANs) or Local Area Networks (LANs), while wireless devices may include wireless communications established via Radio Frequency (RF) signals or infrared signals. Various devices in the system 100 may connect to the network 102 in accordance with various wired and wireless communication protocols such as Transmission Control Protocol and Internet Protocol (TCP/IP), User Datagram Protocol (UDP), and 2G, 3G, or 4G communication protocols.

In some embodiments, the server 104 may be a computer or software module that is configured to provide centralized resources, data, or services to the user device 106 operated by one or more users. The server 104 may be configured to handle and manage one or more computational tasks and data processing within the system 100. In some embodiments, the server 104 may include storage systems, such as hard drives or storage arrays, to store and manage large volumes of data and information accessible to network users. In some embodiments, the server 104 may further provide centralized control and management capabilities, allowing network administrators to configure, monitor, and maintain network resources, security settings, and user access permissions from a single location.

In some embodiments, the server 104 may be configured to receive a first input from one or more users. The first input may correspond to a selection of at least one event from one or more events by the one or more users and a selection of one or more participants by the one or more users. The server 104 may be configured to retrieve event information from an event database and participant data from one or more users database based at least on the received input. Further, the server 104 may be configured to generate the at least one request using the event information and the participant data.

In some embodiments, the server 104 may further be configured to generate at least one request for sending simultaneously to the plurality of GDUs 108 based at least on the first input received. In one example embodiment, the plurality of GDUs 108 may correspond to a plurality of global distribution system (GDS). Further, in the detailed description, the term “GDU” and the term “GDS” holds the same meaning. The at least one request may correspond to a query for retrieving data from the plurality of GDUs 108 corresponding to the received input. The plurality of GDUs 108 may correspond to a network system that maintains a centralized database having aggregated data of the flight details, hotel details, event ticket details, and ground transportation details. The plurality of GDUs 108 may correspond to at least the flight GDU 112, the hotel GDU 110, the ground transportation GDU 114, and the event ticket GDU 116.

In some embodiments, the server 104 may further be configured to receive information from each of the GDUs for each of the one or more participants selected. The information may comprise at least one of flight details, hotel details, event ticket details, and ground transportation details. In some embodiments, the server 104 may further be configured to filter the information for creating one or more itineraries for each of the one or more participants selected, using an artificial intelligence (AI)/machine learning (ML) model. The one or more itineraries may comprise at least one of pricing information and back timing travel information.

In some embodiments, the server 104 may further be configured to display the created one or more itineraries for each of the one or more participants to the one or more users. In some embodiments, the created one or more itineraries may be displayed over the user device 106. In some embodiments, the server 104 may further be configured to determine a second input received from the one or more users. The second input may correspond to accepting, holding, or changing the one or more itineraries for the one or more participants. In some embodiments, the server 104 may further be configured to calculate the pricing information for each of the one or more itineraries based at least on the determination.

In some embodiments, the server 104 may further be configured to train the AI/ML model based at least on the received information from each of the GDUs, real time traffic conditions, weather details, participant data, first input, second input, historical data, and event information. The historical data comprises travel history i.e., users'or participants travel history, modes of transportation selected, time of travel, speed of travel (e.g., walking speed), or expense on travel of the one or more participants. Further, the server 104 may further be configured to determine a current location of the one or more participants using a ground positioning unit (GPU) in real-time. Further, determine whether the one or more participants reach on time for the at least one event. Further, upon determining that the one or more participants are not able to reach on time for the at least one event, the server 104 may further be configured to predict one or more travel routes and transportation for the one or more participants to reach on time for the at least one event using the trained AI/ML model.

In some embodiments, the sever 104 may further predict pricing information for each of the predicted one or more travel routes and transportation for the one or more participants in real-time using the trained AI/ML model. Further, the server 104 may suggest the predicted one or more travel routes and transportation to the one or more participants using the trained AI/ML model based at least on the predicted pricing information. In some embodiments, the server 104 may further update the one or more itineraries based on the calculated pricing information or the predicted pricing information for each of the one or more participants in real-time using the trained AI/ML model. Further, the server 104 may transmit the updated one or more itineraries to the one or more participants and/or the one or more users.

The user device 106 may be equipped by one or more users going to the at least one event from the one or more events. In some embodiments, the calculated pricing information for each of the one or more itineraries may provide a summarized data to the one or more users that is easy to understand. In some embodiments, the user device 106 may include personal computers such as desktop computers, laptop computers, tablets, smartphones, or mobile devices.

It will be apparent to one skilled in the art that above-mentioned components of the system 100 have been provided only for illustration purposes, without departing from the scope of the disclosure.

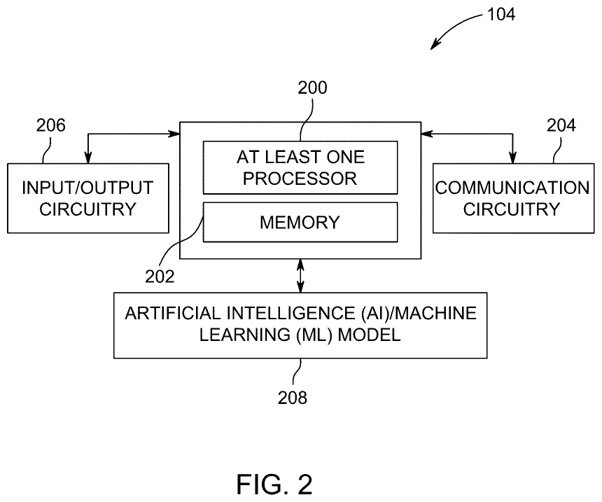

FIG. 2 illustrates a block diagram of the server 104, in accordance with an example embodiment of the present disclosure. FIG. 2 is described in conjunction with FIG. 1.

In some embodiments, the server 104 may comprise at least one processor 200, a memory 202, a communication circuitry 204, an input/output circuitry 206, and an artificial intelligence (AI)/machine learning (ML) model 208. In some embodiments, the at least one processor 200 may be configured to receive the first input from the one or more users. The first input may correspond to the selection of the at least one event from the one or more events by the one or more users and the selection of the one or more participants by the one or more users. The at least one processor 200 may be configured to retrieve event information from an event database and participant data from one or more users database based at least on the first input received. Further, the at least one processor 200 may be configured to generate the at least one request using the event information and the participant data. The event information may comprise at least one of name, location, date, priority, and duration of each of the one or more events. The participant data may comprise at least one of name, date of birth, location of residence, flight preferences, hotel preferences, vehicle preferences, requirement of ground transportation, requirement of hotel, and budget of each of the one or more participants.

In some embodiments, the at least one processor 200 may be configured to generate the at least one request for sending simultaneously to the plurality of GDUs 108 based at least on the received first input. In one example embodiment, sending the at least one request, simultaneously may correspond to concurrent GDU request, i.e., all of the at least one request is sent at the same time to the plurality of GDUs 108. The at least one request may correspond to the query for retrieving the data from the plurality of GDUs 108 corresponding to the received input. The concurrent GDU request may ensure that all of the at least one request is sent at exactly the same time, ensuring that data retrieval queries are processed simultaneously across the plurality of GDUs 108, enhancing efficiency and reducing the time needed for data processing and retrieval from multiple units. In some embodiments, the plurality of GDUs 108 may correspond to a network system that maintains a centralized database having aggregated data of the flight details, hotel details, event ticket details, and ground transportation details. In one example, the plurality of GDUs 108 may correspond to at least the hotel GDU 110, the flight GDU 112, the ground transportation GDU 114 (for example, public taxis, private taxis, share taxis etc.), and the event ticket GDU 116.

In some embodiments, the hotel GDU 110 may manage and distribute data related to hotel details. The hotel GDU 110 may centralize information such as hotel availability, room types, booking options, pricing, and amenities. The hotel GDU 110 may ensure that the one or more users can easily access comprehensive and up-to-date information to make informed decisions about lodging options. In some embodiments, the flight GDU 112 may handle data related to flight details, encompassing flight schedules, airline information, ticket availability, pricing, and booking options. The flight GDU 112 may centralize all necessary flight-related data, allowing the one or more users to retrieve current and accurate flight information quickly, facilitating efficient travel planning and booking processes.

In some embodiments, the ground transportation GDU 114 may be responsible for managing data about ground transportation options, including car rentals, shuttle services, taxis, and public transportation. The ground transportation GDU 114 may centralize and organize the ground transportation options to provide the one or more users with accessible and reliable details about ground transport choices, to plan and arrange transportation from one location to another, easily. In some embodiments, the event ticket GDU 116 may comprise data related to tickets for events such as concerts, sports games, theater performances, and other entertainment activities. The event ticket GDU 116 may centralize information about event schedules, ticket availability, pricing, and seating options. The event ticket GDU 116 may ensure that the one or more users can quickly find and purchase tickets for desired events, providing a streamlined and efficient ticketing experience.

In some embodiments, the at least one processor 200 may be configured to receive the information from each of the GDUs for each of the one or more participants selected. The information may comprise at least one of the flight details, the hotel details, the event ticket details, and the ground transportation details. Further, the flight details may encompass comprehensive information related to air travel, including flight schedules, departure and arrival times, airline names, flight numbers, ticket prices, seat availability, layover details, and any relevant travel restrictions or requirements. Further, the hotel details may provide essential data about accommodation options, including hotel names, locations, room types, availability, pricing, amenities, check-in and check-out times, and user reviews.

Further, the event ticket details may include information corresponding to one or more events such as concerts, sports games, theater performances, and other entertainment activities. The event ticket details may cover event schedules, ticket availability, pricing, seating options, venue locations, and any special conditions or requirements for attendance, enabling the one or more users to plan and secure tickets for desired events. Further, the ground transportation details may offer information about modes of transport available on the ground, such as car rentals, shuttle services, taxis, and public transportation options. The ground transportation details may include pricing, availability, schedules, pick-up and drop-off locations, travel times, and any special instructions, facilitating seamless travel between destinations and events within itinerary of the one or more users.

In some embodiments, the at least one processor 200 may be configured to filter the information for creating the one or more itineraries for each of the one or more participants selected, using the AI/ML model 208. In some embodiments, the at least one processor 200 using the AI/ML model 208, may filter the information for each of the one or more participants based at least on the travel preferences, ground transportation preferences, real time traffic conditions, weather details, participant data, first input, second input, historical data, and event information. The historical data comprises travel history i.e., users'or participants travel history, modes of transportation selected, time of travel, speed of travel (e.g., walking speed), or expense on travel of the one or more participants.

In some embodiments, the at least one processor 200 may be configured to filter information to create separate itineraries for multiple people by first extracting relevant details from the inputted flight, hotel, event, and ground transportation data, then applying logic based on real-time traffic, weather, participant preferences, historical travel data, and event information to optimize each participant's schedule considering factors like travel time, distance, and accessibility. In some embodiments, the at least one processor 200 based on individual needs, filter out irrelevant details for example dietary restrictions for a person not requiring special meals. Further, prioritize transportation options that best align with event schedules, considering factors like event location, start times, and expected duration. Access live traffic conditions and weather forecasts for the destination to estimate travel times accurately. Use past travel patterns of individuals to predict potential delays and optimize routes. For example, if a participant frequently chooses to walk instead of taking public transport, the system might prioritize walking options in their itinerary based on their historical walking speed. The at least one processor 200 may also initiate real-time adjustments to itineraries based on changing conditions like traffic delays or weather events.

The one or more itineraries may comprise at least one of the pricing information and the back timing travel information. In some embodiments, the one or more itineraries may comprise at least one of filtered flight details, hotel details, event ticket details, and ground transportation details for each of the one or more participants, total costs destination arrival/departure time, hotel recommendation offered, traveler preferences, flight class, hotel amenities, ground transport preferences. In some embodiments, the pricing information may comprise budget of each of the one or more participants, a group budget, and budgets for flights, hotels, and ground transportation. In some embodiments, the back timing travel information may comprise desired arrival time, total travel time, start time, and stop time of the one or more participants for the one or more events.

In one example, the AI/ML model 208 may correspond to a collaborative filtering model that is used to recommend flights, hotels, and events based on the preferences and past behaviors of the one or more participants, ensuring that the one or more itineraries align with user preferences. In another example, the AI/ML model 208 may correspond to a supervised learning model, such as regression analysis, to predict the optimal pricing information by learning from back timing travel information and user budgets, providing cost-effective travel options. In yet another example, the AI/ML model 208 may correspond to a clustering model, like k-means clustering, that can group similar travel options together based on factors such as price, travel time, and participant preferences, simplifying the decision-making process. In another example, the AI/ML model 208 may correspond to a natural language processing (NLP) model that can analyze and interpret user inputs regarding desired arrival times, total travel times, and other specific preferences to ensure that the one or more itineraries meet all specified criteria. In yet another example, the AI/ML model 208 may correspond to a reinforcement learning model that can continuously improve suggestions on the one or more itineraries by learning from user feedback and adjusting recommendations to better meet user needs over time.

In some embodiments, the at least one processor 200 may be configured to display the created one or more itineraries for each of the one or more participants to the one or more users. Further, the at least one processor 200 may be configured to determine the second input received from the one or more users. The second input may correspond to unforeseen single or multi user inputs such as accepting, holding, or changing the one or more itineraries for the one or more participants. In some embodiments, the at least one processor 200 may be configured to determine location of the one or more users and the one more participants, based at least on the determination of the second input, using e.g. GPS, train/flight schedules, Google Maps, Waze etc. The location may be determined to be further updated or change in the one or more itineraries in order to predict/suggest the pricing information for each of the one or more itineraries in real-time. In some embodiments, based determined location of each of the one or more participants, the at least one processor 200, using the AI/ML model 208, may also determine/predict/suggest whether all of the one or more participants will arrive on time for the event.

In some embodiments, based on the second input, the at least one processor 200 using the AI/ML model 208, may also be configured to change scheduling of the event, hotel, change flight schedule. In some embodiments, these changes may be made of each specific user or for entire group of the one or more participants. Furthermore, the at least one processor 200 may be configured to calculate the pricing information for each of the one or more itineraries based at least on the determination. Thereafter, the at least one processor 200 may be configured to display payment options associated with the pricing information for the one or more users and for each of the one or more participants, to the one or more users.

In some embodiments, the at least one processor 200 may be configured to train the AI/ML model 208 based at least one the received information from each of the GDUs, real time traffic conditions, weather details, participant data, first input, second input, historical data and event information. The participant data may be retrieved by the at least one processor 200 from one or more users database and the event information may be retrieved by the at least one processor 200 from an event database. In some embodiments, the event information comprises at least one of name, location, date, priority, and duration of each of the one or more events, wherein the participant data comprise at least one of name, date of birth, location of residence, flight preferences, hotel preferences, vehicle preferences, requirement of ground transportation, requirement of hotel, and budget of each of the one or more participants.

In some embodiments, the at least one processor 200 may be configured to determine a current location of the one or more participants using a ground positioning unit (GPU) in real-time. Further, the at least one processor 200 may be configured to determine whether the one or more participants reach on time for the at least one event. In some embodiments, upon determining that any of the one or more participants is going to fail to reach the at least one event on time, the at least one processor 200 may be configured to predict one or more travel routes and transportation for the one or more participants to reach on time for the at least one event using the trained AI/ML model 208.

In some embodiments, the trained AI/ML model 208 may use historical traffic data such as traffic patterns for different times of day, real-time congestion information and expected delays. Further, the AI/ML model 208 may use transportation schedules for bus, train, subway, and other public transports. Further, the AI/ML model 208 may be route potions i.e. available roads, highways, paths (pedestrian, cycling, etc.) along with weather that can impact travel time, especially for modes like walking or cycling. In some embodiments, the AI/ML model 208 may also utilize cost and convenience such as cost of public transport, fuel costs, parking availability or toll roads based on different routes. The AI/ML model 208 may also consider preferences of each of the one or more participants such as walking distance tolerance, preferred modes of transport, or the need to minimize travel time, cost, or effort.

In some embodiments, the at least one processor 200 using the trained AI/ML model 208 may estimate travel time based on different routes, route reliability, transfer or connection time, congestion patters and user context. The at least one processor 200 may evaluate all possible routes based on criteria like estimates time, reliability, preferences, and current conditions. The at least one processor 200 may ensure constraints are satisfied i.e. the one or more participants can arrive on time to the at least one event and thereby may flag the routes that won't allow on-time arrival and focus on those that will. In some embodiments, the at least one processor 200 may combine modes (e.g. walking+bus+train) by balancing total travel time and transfer efficiency.

In some embodiments, the at least one processor 200 may be configured to predict pricing information for each of the predicted one or more travel routes and transportation for the one or more participants in real-time using the trained AI/ML model 208. Further, the at least one processor 200 may suggest the predicted one or more travel routes and transportation to the one or more participants using the trained AI/ML model 208 based at least on the predicted pricing information. Further, the at least one processor 200 may be configured to update the one or more itineraries based on the calculated pricing information or the predicted pricing information for each of the one or more participants in real-time using the trained AI/ML model 208 and transmit the one or more itineraries based on the calculated pricing information or the predicted pricing information for each of the one or more participants in real-time using the trained AI/ML model.

In some embodiments, the one or more participants are enabled to share their travel information with other participants in real time. The at least one processor 200 using the GPU may determine the real time location of each of the one or more participants and share their respective locations with each other. Further, the at least one processor 200 may use the artificial intelligence technique to identify locations of the one or more participants based on medias such as photos and videos uploaded on social media platforms and also use location tags left by the one or more participants. In some embodiments, the at least one processor 200 using the AI technique analyze images taken by a phone camera to identify landmarks and surrounding features, allowing for location estimation based on visual cues.

The at least one processor 200 may include suitable logic, circuitry, and/or interfaces that are operable to execute one or more instructions stored in the memory 202 to perform predetermined operations. In one embodiment, the at least one processor 200 may be configured to decode and execute any instructions received from one or more other electronic devices or server(s). The at least one processor 200 may be configured to execute one or more computer-readable program instructions, such as program instructions to carry out any of the functions described in this description. Further, the at least one processor 200 may be implemented using one or more processor technologies known in the art. Examples of the at least one processor 200 include, but are not limited to, one or more general purpose processors and/or one or more special purpose processors.

In some embodiments, the memory 202 may be configured to store a set of instructions and data executed by the at least one processor 200. Further, the memory 202 may include the one or more instructions that are executable by the at least one processor 200 to perform specific operations. The memory 202 may be configured to include the instructions to receive the first input from the one or more users. The memory 202 may be configured to include the instructions to retrieve the event information from the event database and the participant data from the one or more users database based at least on the received input. The memory 202 may be configured to include the instructions to generate the at least one request using the event information and the participant data. The memory 202 may be configured to include the instructions to generate the at least one request for sending simultaneously to the plurality of GDUs 108 based at least on the received first input. Further, the memory 202 may be configured to include the instructions to receive the information from each of the GDUs for each of the one or more participants selected. The memory 202 may be configured to include the instructions to filter the information for creating the one or more itineraries for each of the one or more participants selected, using the AI/ML model 208.

The memory 202 may be configured to include the instructions to display the created one or more itineraries for each of the one or more participants to the one or more users. The memory 202 may be configured to include the instructions to determine the second input received from the one or more users. The memory 202 may be configured to include the instructions to calculate the pricing information for each of the one or more itineraries based at least on the determination. The memory 202 may be configured to include the instructions to display payment options associated with the pricing information for the one or more users and for each of the one or more participants, to the one or more users. The memory 202 may be configured to include the instructions to update the one or more itineraries based on the received second input. It is apparent to a person with ordinary skill in the art that the one or more instructions stored in the memory 202 enable the hardware of the server 104 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory 202, magnetic or optical cards, or other type of media/machine-readable medium suitable for storing electronic instructions.

In some embodiments, the server 104 may further comprise the communication circuitry 204. The communication circuitry 204 may allow the server 104 to exchange data or information with other systems or apparatuses. Further, the communication circuitry 204 may include network interfaces, protocols, and software modules responsible for sending and receiving data or information. In some embodiments, the communication circuitry 204 may include Ethernet ports, Wi-Fi adapters, or communication protocols like HTTP or MQTT for connecting with other systems. The communication circuitry 204 may further include components such as communication modules (e.g., Wi-Fi, Ethernet, cellular), transceivers, antennas, and protocols (e.g., TCP/IP, MQTT, SNMP) for exchanging data with other systems or network devices. The communication circuitry 204 may allow the server 104 to stay up-to-date and accurately track the pricing information for the one or more users and for each of the one or more participants, to the one or more users, and the one or more itineraries.

In some embodiments, the server 104 may further comprise the input/output circuitry 206. The input/output circuitry 206 may enable the one or more users to communicate or interface with the server 104, via the user device 106. The user device 106 may include N number of user devices. In some embodiments, the input/output circuitry 206 may act as a medium to transmit input from the interface to and from the server 104. In some embodiments, the input/output circuitry 206 may refer to the hardware and software components that facilitate the exchange of information between the user device 106 and the server 104. In one example, the user device 106 may include a graphical user interface (GUI) (not shown) as input circuitry to allow the one or more users to input the first input and the second input. The input/output circuitry 206 may include various input devices such as keyboards, barcode scanners, GUI for the one or more users to provide data and various output devices such as displays, printers for the one or more users to receive the first input and the second input. In another example, the input/output circuitry 206 may include various output circuitry such as a display to show the payment options associated with the pricing information for the one or more users and for each of the one or more participants, to the one or more users.

It will be apparent to one skilled in the art the above-mentioned components of the server 104 have been provided only for illustration purposes, without departing from the scope of the disclosure.

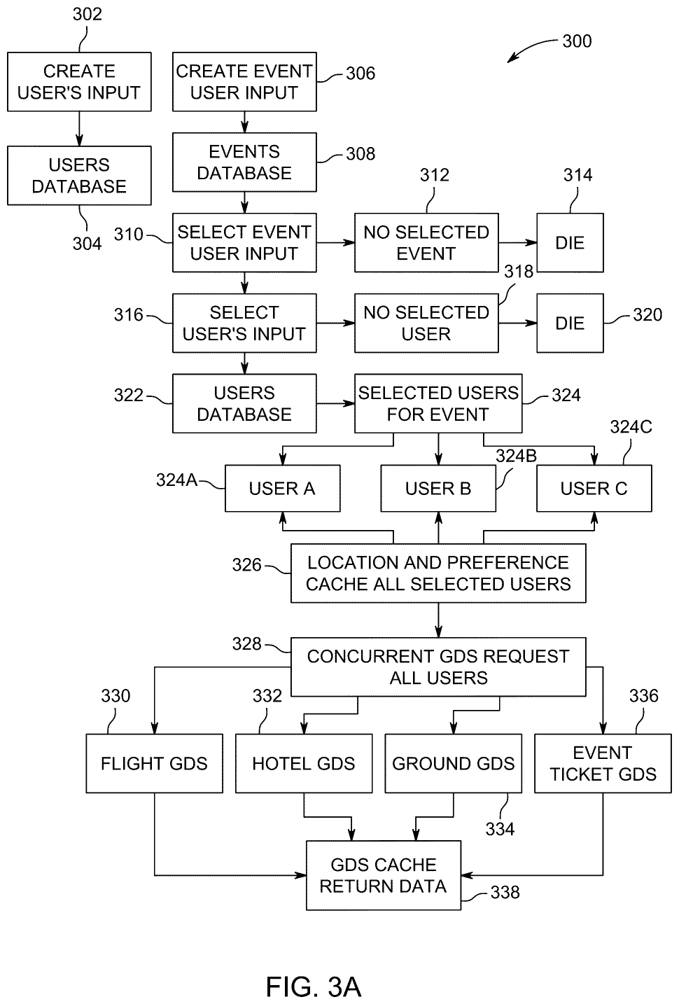

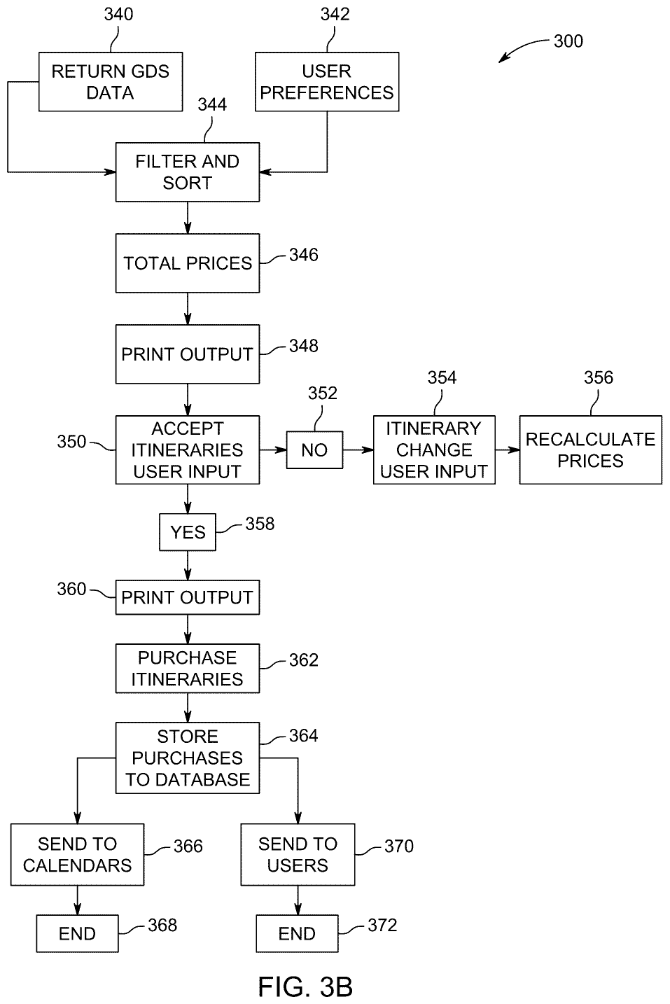

FIGS. 3A-3B illustrate a system flowchart 300 for multi-user concurrent travel, in accordance with an example embodiment of the present disclosure. FIGS. 3A-3B are described in conjunction with FIGS. 1-2.

At operation 302, a user may provide an input having participant data i.e., create user's input. At operation 304, the at least one processor 200 may be configured to save the user input in users database. At operation 306, the at least one processor 200 may be configured to receive the first input i.e., create event user input. At operation 308, the at least one processor 200 may be configured to retrieve event information from the events database. At operation 310, the at least one processor 200 may be configured to select event based on the input i.e., select event user input. At operation 312, the at least one processor 200 may be configured to detect if no event is selected i.e., no event selected. At operation 314, the at least one processor 200 may be configured to end the operations when no event is selected i.e., die.

At operation 316, the at least one processor 200 may be configured to select user's input. At operation 318, the at least one processor 200 may be configured to detect if no selected user. At operation 320, the at least one processor 200 may be configured to end the operations i.e., die. At operation 322, the at least one processor 200 may be configured to retrieve participant data from the users database.

At operation 324, the at least one processor 200 may be configured to select users for event i.e., selected users for event. At operation 324A, the at least one processor 200 may be configured to select a user A. At operation 324B, the at least one processor 200 may be configured to select a user B, simultaneous to the operation 324A. At operation 324C, the at least one processor 200 may be configured to select a user C, simultaneous to the operation 324A and the operation 324 B.

At operation 326, the at least one processor 200 may be configured to determine location and preference cache for all selected users. At operation 328, the at least one processor 200 may be configured to generate and send determined concurrent GDS request to all users, i.e., generate the at least one request for sending simultaneously to the plurality of GDUs 108. At operation 330, the at least one processor 200 may be configured to retrieve data from flight GDS i.e., the flight GDU 112. At operation 332, the at least one processor 200 may be configured to retrieve data from hotel GDS, i.e., the hotel GUS 110, simultaneous to the operation 330. At operation 334, the at least one processor 200 may be configured to retrieve data from ground GDS, i.e., the ground transportation GDU 114, simultaneous to the operation 330 and the operation 332. At operation 336, the at least one processor 200 may be configured to retrieve data from event ticket GDS, i.e., the event ticket GDU 116, simultaneous to the operation 330, the operation 332, and the operation 334.

At operation 338, the at least one processor 200 may be configured to send GDS cache return data, i.e., data from the plurality of GDUs 108. At operation 340, the at least one processor 200 may be configured to return GDS data. At operation 342, the at least one processor 200 may be configured to select user preferences. At operation 344, the at least one processor 200 may be configured to filter and sort the information related to selected user preferences. At operation 346, the at least one processor 200 may be configured to calculate total prices. At operation 348, the at least one processor 200 may be configured to print output of the calculated total prices.

At operation 350, the at least one processor 200 may be configured to accept one or more itineraries user input. In one case, at operation 352, when the user may not accept the one or more itineraries user input, the at least one processor 200 may be configured to itinerary change user input, at operation 354. At operation 356, the at least one processor 200 may be configured to recalculate the prices or calculate the prices again.

In another case, at operation 358, when the user may accept the one or more itineraries user input, the at least one processor 200 may be configured to print output, at operation 360. At operation 362, the at least one processor 200 may be configured to purchase itineraries. At operation 364, the at least one processor 200 may be configured to store purchases to database. At operation 366, the at least one processor 200 may be configured to send to calendars. At operation 368, the at least one processor 200 may be configured to end the operations. At operation 370, the at least one processor 200 may be configured to send to users, simultaneous to the operation 366. At operation 372, the at least one processor 200 may be configured to end the operations.

In one instance, the at least one processor 200 may be configured to predict the one or more travel routes and transportation for the one or more participants to reach on time for the at least one event using the trained AI/ML model 208 in case any of the one or more participants are not able to reach on time for the at least one event. In one example, a person “Mads” is an artist and needs to reach a concert at 9:00 AM, and the at least one processor 200 calculates travel time for car, bus, and subway routes. Further, the at least one processor 200 retrieves historical traffic data, real-time bus schedules, and the weather information. Further, the at least one processor 200 using the trained AI/ML model 208 predicts a travel time for each route, accounting for transfers and delays. The at least one processor 200 identifies that the car route is fastest but has a higher uncertainty due to potential traffic. A subway-bus combination, although slightly slower, has a higher reliability score. The at least one processor 200 thereby recommends the subway-bus option based on its higher likelihood of on-time arrival, while informing Mads of the potential risks and benefits of each option.

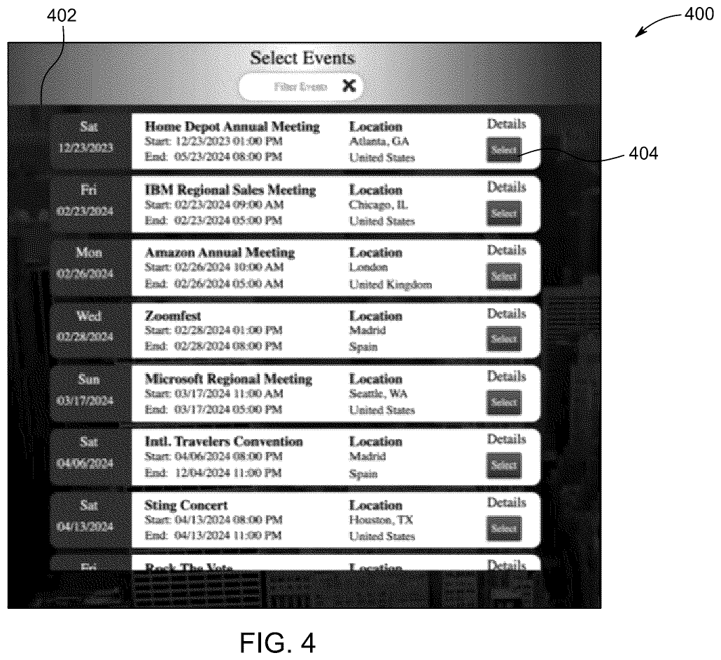

FIG. 4 illustrates a user interface (UI) 400 showing selection of at least one event, in accordance with an example embodiment of the present disclosure. FIG. 4 is described in conjunction with FIGS. 1-3B.

The UI 400 may provide selection of at least one event from the one or more events. The UI 400 may comprise a list of events 402 as “select events”. The list of events 402 may allow the one or more users to view and select at least one event from a list of the one or more events. The list of events 402 may provide an organized and easily navigable interface for the one or more users to browse through available events and make selections based on preferences of the one or more users. Further, each event on the list of events 402 may comprise a select button 404 to view the details of each event on the list of events 402.

In one example, the list of events 402 may comprise an event “Home Depot Annual Meeting” with a date of the event as “Sat 12/23/2023” and a location of the event as “Atlanta, GA United States”. Further, the event “Home Depot Annual Meeting” comprises a start time as “Start: Dec. 23, 2023 01:00 PM” and a stop time as “End: May 23, 2024 08:00 PM”. A user may click on the select button 404 to view the details of the event “Home Depot Annual Meeting”.

In another example, the list of events 402 may comprise an event “IBM Regional Sales Meeting” with a date of the event as “Fri 02/23/2024” and a location of the event as “Chicago, IL United States”. Further, the event “IBM Regional Sales Meeting” comprises a start time as “Start: Feb. 23, 2024 09:00 AM” and a stop time as “End: Feb. 23, 2024 05:00 PM”. A user may click on the select button 404 to view the details of the event “IBM Regional Sales Meeting”.

In yet another example, the list of events 402 may comprise an event “Amazon Annual Meeting” with a date of the event as “Mon 02/26/2024” and a location of the event as “London United Kingdom”. Further, the event “Amazon Annual Meeting” comprises a start time as “Start: Feb. 26, 2024 10:00 AM” and a stop time as “End: Feb. 26, 2024 05:00 AM”. A user may click on the select button 404 to view the details of the event “Amazon Annual Meeting”.

In another example, the list of events 402 may comprise an event “Fest” with a date of the event as “Wed 02/28/2024” and a location of the event as “Madrid Spain”. Further, the event “Fest” comprises a start time as “Start: Feb. 28, 2024 01:00 PM” and a stop time as “End: Feb. 28, 2024 08:00 PM”. A user may click on the select button 404 to view the details of the event “Fest”.

In yet another example, the list of events 402 may comprise an event “Microsoft Regional Meeting” with a date of the event as “Sun 03/17/2024” and a location of the event as “Seattle, WA United States”. Further, the event “Microsoft Regional Meeting” comprises a start time as “Start: Mar. 17, 2024 11:00 AM” and a stop time as “End: Mar. 17, 2024 05:00 PM”. A user may click on the select button 404 to view the details of the event “Microsoft Regional Meeting”.

In another example, the list of events 402 may comprise an event “Intl. Travelers Convention” with a date of the event as “Sat 04/06/2024” and a location of the event as “Madrid Spain”. Further, the event “Intl. Travelers Convention” comprises a start time as “Start: Apr. 6, 2024 08:00 PM” and a stop time as “End: Dec. 4, 2024 11:00 PM”. A user may click on the select button 404 to view the details of the event “Intl. Travelers Convention”.

In yet another example, the list of events 402 may comprise an event “Sting Concert” with a date of the event as “Sat 04/13/2024” and a location of the event as “Houston, TX United States”. Further, the event “Sting Concert” comprises a start time as “Start: Apr. 13, 2024 08:00 PM” and a stop time as “End: Apr. 13, 2024 11:00 PM”. A user may click on the select button 404 to view the details of the event “Sting Concert”.

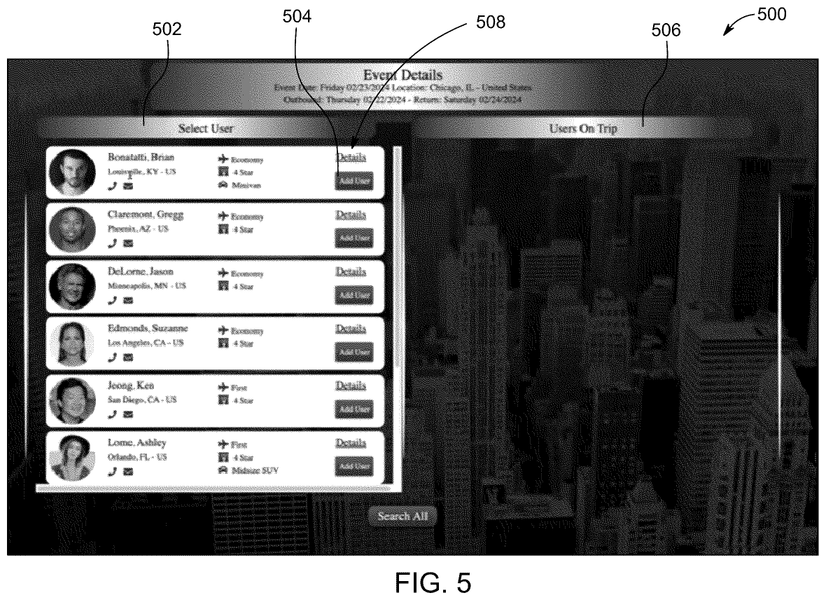

FIG. 5 illustrates a UI 500 showing a list of the one or more participants, in accordance with an example embodiment of the present disclosure. FIG. 5 is described in conjunction with FIGS. 1-4.

The UI 500 may provide the list of the one or more participants based on selection of the at least one event from the one or more events. The UI 500 may comprise a list of the one or more participants 502 as “select user”. When a one or more users selects an event, the UI 500 may display the list of one or more participants, allowing the one or more users to choose which participant will be included in the travel plans and the one or more itineraries. Further, each participant from the list of participants may comprise an add user button 504 to add the participant to a list of users on trip 506. The list of users on trip 506 may comprise a detail of each of the one or more participants that are coming to the event. Furthermore, each participant from the list of participants may comprise a details hyperlink 508 to view the details of the participant.

In one example embodiment, the event “IBM Regional Sales Meeting” with a date of the event as “Fri 02/23/2024” and a location of the event as “Chicago, IL United States” may be selected. In one example, the list of the one or more participants 502 of the event may comprise details of a participant named “Bonatatti, Brian” with a location of the participant as “Louisville, KY-US”. Further, the details may comprise the flight details, the hotel details, the ground transportation details. A user may click on the add user button 504 to add the participant to the list of the users on trip 506. Further, a user may click on the details hyperlink 508 to view the details of the participant.

In another example, the list of the one or more participants 502 of the event may comprise details of a participant named “Claremont, Gregg” with a location of the participant as “Phoenix, AZ-US”. Further, the details may comprise the flight details and the hotel details. A user may click on the add user button 504 to add the participant to the list of the users on trip 506. Further, a user may click on the details hyperlink 508 to view the details of the participant. In yet another example, the list of the one or more participants 502 of the event may comprise details of a participant named “DeLorne, Jason” with a location of the participant as “Minneapolis, MN-US”. Further, the details may comprise the flight details and the hotel details. A user may click on the add user button 504 to add the participant to the list of the users on trip 506. Further, a user may click on the details hyperlink 508 to view the details of the participant.

In another example, the list of the one or more participants 502 of the event may comprise details of a participant named “Edmonds, Suzanne” with a location of the participant as “Los Angeles, CA-US”. Further, the details may comprise the flight details and the hotel details. A user may click on the add user button 504 to add the participant to the list of the users on trip 506. Further, a user may click on the details hyperlink 508 to view the details of the participant. In yet another example, the list of the one or more participants 502 of the event may comprise details of a participant named “Jeong, Ken” with a location of the participant as “San Diego, CA-US”. Further, the details may comprise the flight details and the hotel details. A user may click on the add user button 504 to add the participant to the list of the users on trip 506. Further, a user may click on the details hyperlink 508 to view the details of the participant.

In another example, the list of the one or more participants 502 of the event may comprise details of a participant named “Lome, Ashley” with a location of the participant as “Orlando, FL-US”. Further, the details may comprise the flight details, the hotel details and the ground transportation details. A user may click on the add user button 504 to add the participant to the list of the users on trip 506. Further, a user may click on the details hyperlink 508 to view the details of the participant.

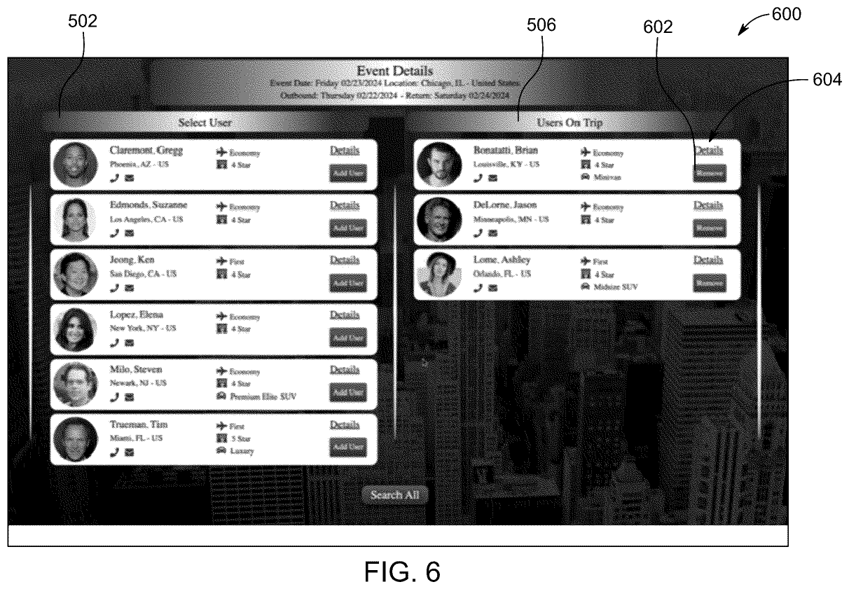

FIG. 6 illustrates a UI 600 showing the list of one or more participants selected, in accordance with an example embodiment of the present disclosure. FIG. 6 is described in conjunction with FIG. 5.

The UI 600 may provide the list of the one or more participants selected based on adding each participant to the list of the users on the trip 506. The UI 600 may comprise the list of the users on trip 506. Further, each participant from the list of the users on trip 506 may comprise a remove button 602 to remove the participant from the list of the users on trip 506. Furthermore, each participant from the list of the users on trip 506 may comprise a details hyperlink 604 to view the details of the participant from the list of the users on trip 506.

In one example embodiment, the event “IBM Regional Sales Meeting” with a date of the event as “Fri 02/23/2024” and a location of the event as “Chicago, IL United States” may be selected. In one example, the list of the users on trip 506 coming to the event may comprise details of the participant named “Bonatatti, Brian” with the location of the participant as “Louisville, KY-US”. Further, the details may comprise the flight details, the hotel details and the ground transportation details. A user may click on the remove button 602 to remove the participant from the list of the users on trip 506. Further, a user may click on the details hyperlink 604 to view the details of the participant.

In another example, the list of the users on trip 506 coming to the event may comprise details of the participant named “DeLorne, Jason” with the location of the participant as “Minneapolis, MN-US”. Further, the details may comprise the flight details, the hotel details and the ground transportation details. A user may click on the remove button 602 to remove the participant from the list of the users on trip 506. Further, a user may click on the details hyperlink 604 to view the details of the participant. In yet another example, the list of the users on trip 506 coming to the event may comprise details of the participant named “Lome, Ashley” with the location of the participant as “Orlando, FL-US”. Further, the details may comprise the flight details, the hotel details and the ground transportation details. A user may click on the remove button 602 to remove the participant from the list of the users on trip 506. Further, a user may click on the details hyperlink 604 to view the details of the participant.

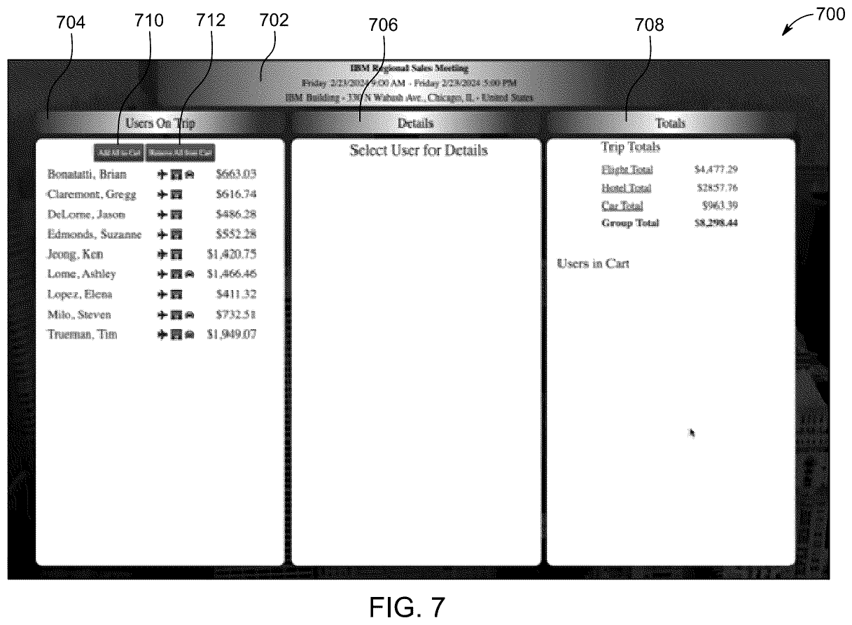

FIG. 7 illustrates a UI 700 showing total budget details in accordance with an example embodiment of the present disclosure. FIG. 7 is described in conjunction with FIG. 6.

The UI 700 may provide total budget details 702 of each participant from the list of the users on trip 506 based on selection of the at least one event from the one or more events. The UI 700 may comprise a pricing information 704 of the list of the one or more participants 502 as “select user”, an itinerary detail 706 of the participant denoted as “details”, and a total 708 of the participant. The budget details 702 may provide individual budget information for each participant from the list of users on the trip 506. The pricing information 704 may show the cost details for the selected participants, labeled as “select user”. The itinerary detail 706 may offer specific travel-related information for each participant, denoted as “details”. The total 708 may summarize the overall costs for each participant. Further, the pricing information 704 may comprise a “add all to cart” button 710 to quickly add all of the one or more users from the list of the users on trip 506 and a “remove all from cart” button 712 to remove all the users.

In one example, the budget details 702 may comprise a pricing information 704 of the participant name “Bonatatti, Brian” as $663.03. In another example, the budget details 702 may comprise a pricing information 704 of the participant name “Claremont, Gregg” as $616.74. In yet another example, the budget details 702 may comprise a pricing information 704 of the participant name “DeLorne, Jason” as $486.28. In another example, the budget details 702 may comprise a pricing information 704 of the participant name “Edmonds, Suzanne” as $553.38. In yet another example, the budget details 702 may comprise a pricing information 704 of the participant name “Jeong, Ken” as $1420.75. In another example, the budget details 702 may comprise a pricing information 704 of the participant name “Lome, Ashley” as $1466.46.

In yet another example, the budget details 702 may comprise a pricing information 704 of a participant name “Lopez, Elena” as $411.32. In another example, the budget details 702 may comprise a pricing information 704 of a participant name “Milo, Steven” as $732.51. In yet another example, the budget details 702 may comprise a pricing information 704 of a participant name “Trueman, Tim” as $1949.07. Further, the budget details 702 may comprise a total 708 of the all the participants as trip totals having a flight total of $4477.29, a hotel total of $2857.76, a car total of $963.39 with a group total of $8298.44.

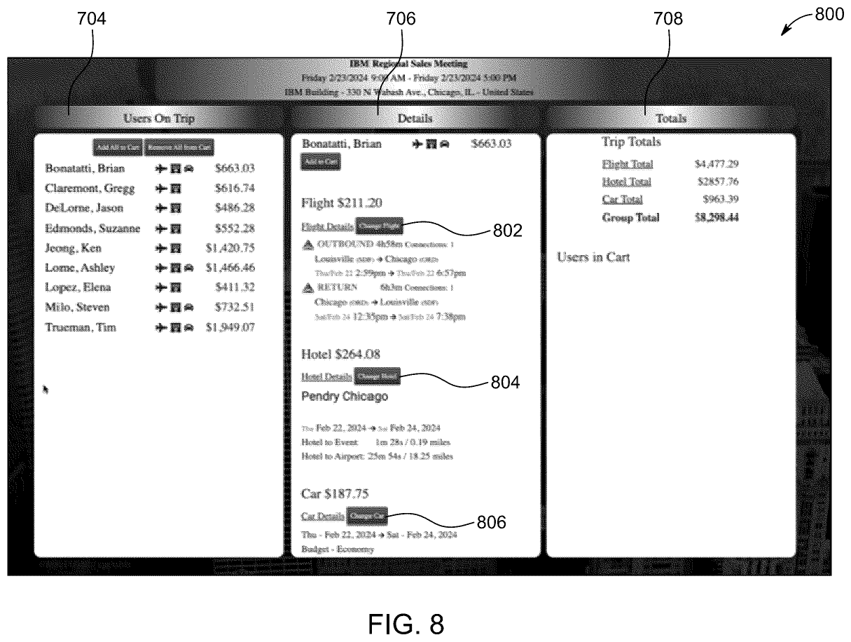

FIG. 8 illustrates a UI 800 showing the itinerary detail 706, in accordance with an example embodiment of the present disclosure. FIG. 8 is described in conjunction with FIG. 7.

The UI 800 may provide the itinerary detail 706 of the one or more participants based on selection of the at least one event from the one or more events. The UI 800 may comprise the itinerary detail 706 as “details” comprising the back timing travel information having desired arrival time, total travel time, start time, and stop time of the one or more participants for the one or more events. Further, the itinerary detail 706 may comprise a change flight button 802 to reschedule the fight of the participant. Furthermore, the itinerary detail 706 may comprise a change hotel button 804 to change the hotel at which the participant will stay. Further, the itinerary detail 706 may comprise a change car button 806 to change the ground transportation of the participant.

In one example embodiment, the participant name “Bonatatti, Brian” may be selected. In one example, the itinerary detail 706 may comprise the filtered flight details having the outbound and return, the hotel details having the name and distance from the hotel, and the ground transportation details as “car details” having the budget for the ground transportation, of the participant named “Bonatatti, Brian”.

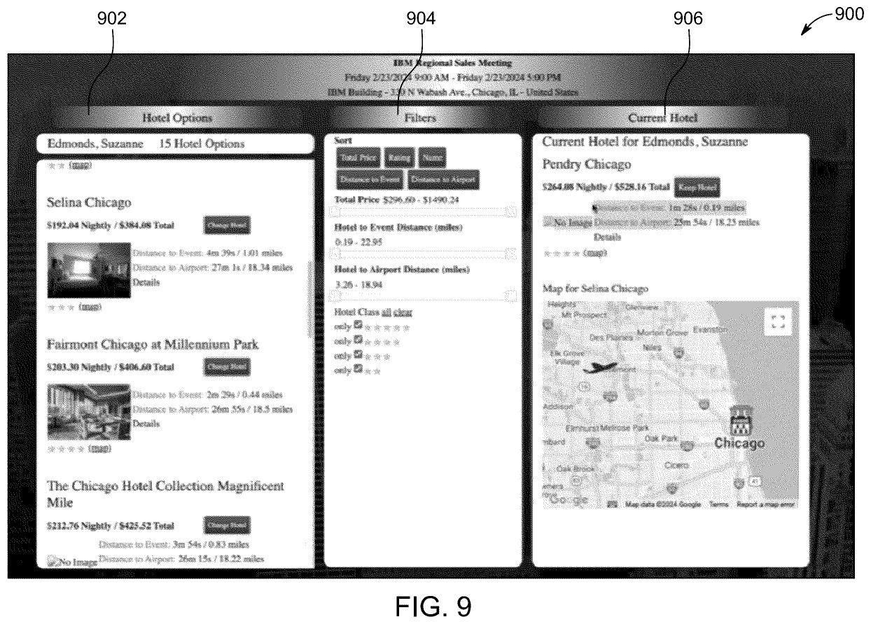

FIG. 9 illustrates a UI 900 showing hotel options, in accordance with an example embodiment of the present disclosure. FIG. 9 is described in conjunction with FIGS. 1-8.

The UI 900 may provide hotel option for the list of the one or more users on trip 506. The UI 900 may comprise hotel options 902, filter options 904 and details of current hotel 906. The hotel options 902 may provide comprehensive information about available hotels, including descriptions, pricing, room types, and reviews. The filter options 904 may allow the one or more participants to refine the search based on various criteria such as price, location, amenities, and ratings. The details of the current hotel 906 may display specific information about the hotel currently selected or booked by the one or more users such as location, price, distance to airport/event, rating, etc.

In one example, for the participant named “Edmonds, Suzanne”, the UI 900 may comprise the hotel options 902 showing information about available hotels, including descriptions, pricing, room types, and reviews. The UI 900 may comprise the filter options 904 to refine the search based on various criteria such as price, location, amenities, and ratings. The UI 900 may comprise the details of the current hotel 906 showing specific information about the hotel currently selected or booked by the one or more users such as location, price, distance to airport/event, rating, etc.

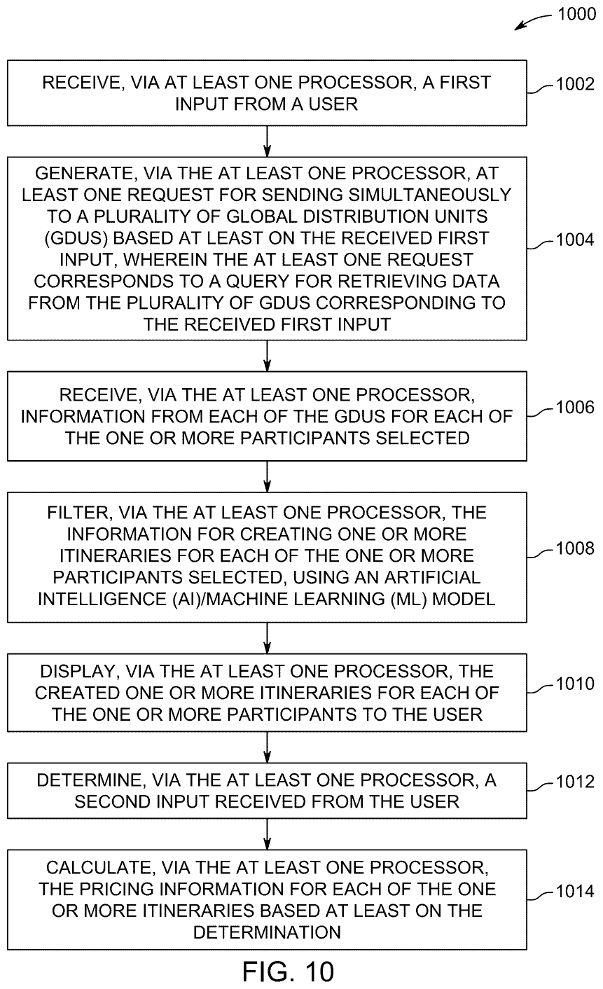

FIG. 10 illustrates a flowchart showing a method 1000 for multi-user concurrent travel, in accordance with an example embodiment of the present disclosure. FIG. 10 is described in conjunction with FIGS. 1-9.

At operation 1002, the at least one processor 200 may be configured to receive the first input from the one or more users. The first input may correspond to the selection of the at least one event from the one or more events by the one or more users and the selection of the one or more participants by the one or more users. In some embodiments, the method may further comprise retrieving, via the at least one processor 200, the event information from the event database and the participant data from the one or more users database based at least on the received input. In some embodiments, the event information may comprise at least one of name, location, date, priority, and duration of each of the one or more events. In some embodiments, the participant data may comprise at least one of name, date of birth, location of residence, flight preferences, hotel preferences, vehicle preferences, requirement of ground transportation, requirement of hotel, and budget of each of the one or more participants. Thereafter, the method may comprise generating, via the at least one processor 200, the at least one request using the event information and the participant data.

At operation 1004, the at least one processor 200 may be configured to generate the at least one request for sending simultaneously to the plurality of GDUs 108 based at least on the received first input. The at least one request may correspond to the query for retrieving the data from the plurality of GDUs 108 corresponding to the received first input. In some embodiments, the plurality of GDUs 108 may correspond to the network system that maintains the centralized database having aggregated data of the flight details, hotel details, event ticket details, and ground transportation details. In one example, the plurality of GDUs 108 may correspond to at least the flight GDU 112, the hotel GDU 110, the ground transportation GDU 114, and the event ticket GDU 116.

At operation 1006, the at least one processor 200 may be configured to receive the information from each of the GDUs for each of the one or more participants selected. The information may comprise at least one of the flight details, the hotel details, the event ticket details, and the ground transportation details. At operation 1008, the at least one processor 200 may be configured to filter the information for creating the one or more itineraries for each of the one or more participants selected, using the AI/ML model 208. The one or more itineraries may comprise at least one of the pricing information and the back timing travel information. In some embodiments, the one or more itineraries may comprise at least one of the filtered flight details, the hotel details, the event ticket details, and the ground transportation details for each of the one or more participants. In some embodiments, the pricing information may comprise the budget of each of the one or more participants, the group budget, and the budgets for flights, hotels, and ground transportation. In some embodiments, the back timing travel information may comprise the desired arrival time, the total travel time, the start time, and the stop time of the one or more participants for the one or more events.

At operation 1010, the at least one processor 200 may be configured to display the created one or more itineraries for each of the one or more participants to the one or more users. At operation 1012, the at least one processor 200 may be configured to determine the second input received from the one or more users. The second input may correspond to accepting, holding, or changing the one or more itineraries for the one or more participants. At operation 1014, the at least one processor 200 may be configured to calculate the pricing information for each of the one or more itineraries based at least on the determination.

In some embodiments, the at least one processor 200 may be configured to train the AI/ML model 208 based at least one the received information from each of the GDUs, real time traffic conditions, weather details, participant data and event information. The participant data may be retrieved by the at least one processor 200 from one or more users database and the event information may be retrieved by the at least one processor 200 from an event database. In some embodiments, the event information comprises at least one of name, location, date, priority, and duration of each of the one or more events, wherein the participant data comprise at least one of name, date of birth, location of residence, flight preferences, hotel preferences, vehicle preferences, requirement of ground transportation, requirement of hotel, and budget of each of the one or more participants.

In some embodiments, the at least one processor 200 may be configured to determine a current location of the one or more participants using a ground positioning unit (GPU) in real-time. Further, the at least one processor 200 may be configured to determine whether the one or more participants reach on time for the at least one event. In some embodiments, upon determining that any of the one or more participants is going to fail to reach the at least one event on time, the at least one processor 200 may be configured to predict one or more travel routes and transportation for the one or more participants to reach on time for the at least one event using the trained AI/ML model 208.

In some embodiments, the at least one processor 200 may be configured to predict pricing information for each of the predicted one or more travel routes and transportation for the one or more participants in real-time using the trained AI/ML model 208. Further, the at least one processor 200 may be configured to suggest the predicted one or more travel routes and transportation to the one or more participants using the trained AI/ML model 208 based at least on the predicted pricing information. Further, the at least one processor 200 may be configured to update the one or more itineraries based on the calculated pricing information or the predicted pricing information for each of the one or more participants in real-time using the trained AI/ML model 208. Further, the at least one processor 200 may be configured to transmit the updated one or more itineraries to the one or more participants and/or the one or more users.

In some embodiments, the method may further comprise displaying, via the at least one processor 200, payment options associated with the pricing information for the one or more users and for each of the one or more participants, to the one or more users. In some embodiments, the method may further comprise updating, via the at least one processor 200, the one or more itineraries based on the received second input.

In an exemplary embodiment, a non-transitory machine-readable information storage medium is disclosed. The non-transitory machine-readable information storage medium comprising one or more instructions which when executed by at least one processor 200 may cause the at least one processor 200 to receive the first input from the one or more users. The first input may correspond to the selection of the at least one event from the one or more events by the one or more users and the selection of the one or more participants by the one or more users. In some embodiments, the one or more instructions which when executed by at least one processor 200 may cause the at least one processor 200 to generate the at least one request for sending simultaneously to the plurality of GDUs 108 based at least on the received first input. The at least one request may correspond to the query for retrieving the data from the plurality of GDUs 108 corresponding to the received input.

In some embodiments, the one or more instructions which when executed by at least one processor 200 may cause the at least one processor 200 to receive the information from each of the GDUs for each of the one or more participants selected. The information may comprise at least one of the flight details, the hotel details, the event ticket details, and the ground transportation details. In some embodiments, the one or more instructions which when executed by at least one processor 200 may cause the at least one processor 200 to filter the information for creating the one or more itineraries for each of the one or more participants selected, using the AI/ML model 208. The one or more itineraries may comprise at least one of the pricing information and the back timing travel information.

In some embodiments, the one or more instructions which when executed by at least one processor 200 may cause the at least one processor 200 to display the created one or more itineraries for each of the one or more participants to the one or more users. In some embodiments, the one or more instructions which when executed by at least one processor 200 may cause the at least one processor 200 to determine the second input received from the one or more users. The second input may correspond to accepting, holding, or changing the one or more itineraries for the one or more participants. In some embodiments, the one or more instructions which when executed by at least one processor 200 may cause the at least one processor 200 to calculate the pricing information for each of the one or more itineraries based at least on the determination.

In another example embodiment, the at least one processor 200 may also be configured to allow the multiple users and participants to find a suitable destination around the globe or a country that best suites multiple condition of the users and the participants. In some embodiments, the at least one processor 200 may provide suitable destinations for the users and the participants based on the budget of a group, maximum time to spend by the group, season of travel, time or travel, suitable climate etc. The at least one processor 200 takes all the flight, hotel, and local cost data into account for each participant of the group in order to determine the most cost-effective destinations for the trip.

The present disclosure may allow multiple users to select events and participants simultaneously, enhancing collaboration and coordination among travelers. The present disclosure may efficiently generate and send requests to the plurality of global distribution units (GDUs), ensuring comprehensive data retrieval from multiple sources. The present disclosure may centralize, compile and organize diverse information, such as flight, hotel, event ticket, and ground transportation details, providing users with all necessary travel data in one place to provide cost reduction benefit to each participant. The use of AI and machine learning models may enable intelligent filtering and creation of personalized itineraries for each participant, optimizing travel plans based on individual preferences and needs. The present disclosure may offer dynamic pricing information and back-timing travel details, helping users make informed decisions about their travel plans. Further, a user-friendly interface may be provided for displaying itineraries, allowing users to easily review and manage their travel plans. The present disclosure may enable real-time calculations of pricing and itinerary adjustments based on user inputs, offering flexibility and adaptability to changing travel requirements.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

### LIST OF ELEMENTS

100—System
102—Network
104—Server
106—User device
108—Global distribution units (GDUs)
110—Hotel GDU
112—Flight GDU
114—Ground transportation GDU
116—Event ticket GDU
200—At least one processor
202—Memory
204—Communication circuitry
206—Input/Output circuitry
208—Artificial Intelligence(AI)/Machine Learning (ML) model
300—System Flowchart
302—Create user input
304—Users'database
306—Create event user input
308—Events database
310—Select event user input
312—No selected event
314—Die
316—Select users user input
318—No selected user
320—Die
322—Users'database
324—Selected users for event
324a—User A
324b-User B
324c—User C
326—Location and preference cache all selected users
328—Concurrent GDS request all users
330—Flight GDS
332—Hotel GDS
334—Ground GDS
336—Event ticket GDS
338—GDS cache return data
340—Return GDS data
342—User preferences
344—Filter and sort
346—Total prices
348—Print output
350—Accept itineraries user input
352—No
354—Itinerary change user input
356—Recalculate prices
358—Yes
360—Print output
362—Purchase itineraries
364—Store purchases to database
366—Send to calendars
368—End
370—Send to users
372—End
400—User Interface (UI)
404—Select button
500—UI
502—List of one or more participants
504—Add user button
506—List of users on trip
508—Details hyperlink
600—UI
602—Remove button
604—Details hyperlink
700—UI
702—Total budget details
704—Pricing information
706—Itinerary detail
708—Total
710—Add all to cart
712—Remove all from cart
800—UI
802—Change flight button
804—Change hotel button
806—Change car button
900—UI
902—Hotel options
904—Filter options
906—Details of current hotel
1000—Method
1002—Step
1004—Step
1008—Step
1010—Step
1012—Step
1014—Step

What is claimed is:

1. A method comprising:
receiving, via at least one processor, a first input from one or more users, wherein the first input corresponds to a selection of at least one event from one or more events by the one or more users and a selection of one or more participants by the one or more users;
generating, via the at least one processor, at least one request for sending simultaneously to a plurality of global distribution units (GDUs) based at least on the first input received, wherein the at least one request corresponds to a query for retrieving data from the plurality of GDUs corresponding to the received first input;
receiving, via the at least one processor, information from each of the GDUs for each of the one or more participants selected, wherein the information comprises at least one of flight details, hotel details, event ticket details, and ground transportation details;
filtering, via the at least one processor, the information for creating one or more itineraries for each of the one or more participants selected, using an artificial intelligence (AI)/machine learning (ML) model, wherein the one or more itineraries comprise at least one of pricing information and back timing travel information;
displaying, via the at least one processor, the created one or more itineraries for each of the one or more participants to the one or more users;
determining, via the at least one processor, a second input received from the one or more users, wherein the second input corresponds to accepting, holding, or changing the one or more itineraries for the one or more participants; and
calculating, via the at least one processor, the pricing information for each of the one or more itineraries based at least on a determination of the second input.

2. The method of claim 1, further comprising training, via the at least one processor, the AI/ML model based at least on the received information from each of the GDUs, real time traffic conditions, weather details, participant data, first input, second input, historical data, and event information.

3. The method of claim 2, further comprising:
determining, via the at least one processor, a current location of the one or more participants using a ground positioning unit (GPU) in real-time;
determining, via the at least one processor, whether the one or more participants reach on time for the at least one event; and
predicting, via the at least one processor, one or more travel routes and transportation for the one or more participants to reach on time for the at least one event using the trained AI/ML model upon determining that the one or more participants are not able to reach on time for the at least one event.

4. The method of claim 3, further comprising:
predicting, via the at least one processor, pricing information for each of the predicted one or more travel routes and transportation for the one or more participants in real-time using the trained AI/ML model; and
suggesting, via the at least one processor, the predicted one or more travel routes and transportation to the one or more participants using the trained AI/ML model based at least on the predicted pricing information.

5. The method of claim 4, further comprising:
updating, via the at least one processor, the one or more itineraries based on the calculated pricing information or the predicted pricing information for each of the one or more participants in real-time using the trained AI/ML model; and
transmitting, via the at least one processor, the updated one or more itineraries to the one or more participants and/or the one or more users.

6. The method of claim 2, further comprising:
retrieving, via the at least one processor, the event information from an event database and the participant data from one or more users database based at least on the received input.

7. The method of claim 6, wherein the event information comprises at least one of name, location, date, priority, and duration of each of the one or more events, wherein the participant data comprise at least one of name, date of birth, location of residence, flight preferences, hotel preferences, vehicle preferences, requirement of ground transportation, requirement of hotel, and budget of each of the one or more participants.

8. The method of claim 1, wherein the plurality of GDUs correspond to a network system that maintains a centralized database having aggregated data of the flight details, hotel details, event ticket details, and ground transportation details, wherein the plurality of GDUs correspond to at least a flight GDU, a hotel GDU, a ground transportation GDU, and an event ticket GDU.

9. The method of claim 1, wherein the one or more itineraries comprise at least one of filtered flight details, hotel details, event ticket details, and ground transportation details for each of the one or more participants, and wherein the back timing travel information comprises desired arrival time, total travel time, start time, and stop time of the one or more participants for the one or more events.

10. The method of claim 1, further comprising displaying, via the at least one processor, payment options associated with the pricing information for the one or more users and for each of the one or more participants, to the one or more users, and wherein the pricing information comprises budget of each of the one or more participants, a group budget, and budgets for flights, hotels, and ground transportation.

11. A system comprising:
at least one processor configured to:
receive a first input from one or more users, wherein the first input corresponds to a selection of at least one event from one or more events by the one or more users and a selection of one or more participants by the one or more users;
generate at least one request for sending simultaneously to a plurality of global distribution units (GDUs) based at least on the first input received, wherein the at least one request corresponds to a query for retrieving data from the plurality of GDUs corresponding to the received first input;
receive information from each of the GDUs for each of the one or more participants selected, wherein the information comprises at least one of flight details, hotel details, event ticket details, and ground transportation details;
filter the information for creating one or more itineraries for each of the one or more participants selected, using an artificial intelligence (AI)/machine learning (ML) model, wherein the one or more itineraries comprise at least one of pricing information and back timing travel information;
display the created one or more itineraries for each of the one or more participants to the one or more users;
determine a second input received from the one or more users, wherein the second input corresponds to accepting, holding, or changing the one or more itineraries for the one or more participants; and
calculate the pricing information for each of the one or more itineraries based at least on a determination of the second input.

12. The system of claim 11, wherein the at least one processor is configured to train the AI/ML model based at least on the received information from each of the GDUs, real time traffic conditions, weather details, participant data, first input, second input, historical data, and event information.

13. The system of claim 12, wherein the at least one processor is configured to:
determine a current location of the one or more participants using a ground positioning unit (GPU) in real-time;
determine whether the one or more participants reach on time for the at least one event; and
predict one or more travel routes and transportation for the one or more participants to reach on time for the at least one event using the trained AI/ML model upon determining that the one or more participants are not able to reach on time for the at least one event.

14. The system of claim 13, wherein the at least one processor is configured to:
predict pricing information for each of the predicted one or more travel routes and transportation for the one or more participants in real-time using the trained AI/ML model; and
suggest the predicted one or more travel routes and transportation to the one or more participants using the trained AI/ML model based at least on the predicted pricing information.

15. The system of claim 14, wherein the at least one processor is configured to:
update the one or more itineraries based on the calculated pricing information or the predicted pricing information for each of the one or more participants in real-time using the trained AI/ML model; and
transmit the updated one or more itineraries to the one or more participants and/or the one or more users.

16. The system of claim 12, wherein the at least one processor is configured to retrieve the event information from an event database and the participant data from one or more users database based at least on the received input, wherein the event information comprises at least one of name, location, date, priority, and duration of each of the one or more events, wherein the participant data comprise at least one of name, date of birth, location of residence, flight preferences, hotel preferences, vehicle preferences, requirement of ground transportation, requirement of hotel, and budget of each of the one or more participants.

17. The system of claim 11, wherein the plurality of GDUs correspond to a network system that maintains a centralized database having aggregated data of the flight details, hotel details, event ticket details, and ground transportation details, wherein the plurality of GDUs correspond to at least a flight GDU, a hotel GDU, a ground transportation GDU, and an event ticket GDU.

18. The system of claim 11, wherein the one or more itineraries comprise at least one of filtered flight details, hotel details, event ticket details, and ground transportation details for each of the one or more participants, and wherein the back timing travel information comprises desired arrival time, total travel time, start time, and stop time of the one or more participants for the one or more events.

19. The system of claim 11, wherein the at least one processor is configured to display payment options associated with the pricing information for the one or more users and for each of the one or more participants, to the one or more users, and wherein the pricing information comprises budget of each of the one or more participants, a group budget, and budgets for flights, hotels, and ground transportation.

20. A non-transitory machine-readable information storage medium comprising one or more instructions which when executed by at least one processor cause the at least one processor to:
receive a first input from one or more users, wherein the first input corresponds to a selection of at least one event from one or more events by the one or more users and a selection of one or more participants by the one or more users;
generate at least one request for sending simultaneously to a plurality of global distribution units (GDUs) based at least on the first input received, wherein the at least one request corresponds to a query for retrieving data from the plurality of GDUs corresponding to the received first input;
receive information from each of the GDUs for each of the one or more participants selected, wherein the information comprises at least one of flight details, hotel details, event ticket details, and ground transportation details;
filter the information for creating one or more itineraries for each of the one or more participants selected, using an artificial intelligence (AI)/machine learning (ML) model, wherein the one or more itineraries comprise at least one of pricing information and back timing travel information;
display the created one or more itineraries for each of the one or more participants to the one or more users;
determine a second input received from the one or more users, wherein the second input corresponds to accepting, holding, or changing the one or more itineraries for the one or more participants; and
calculate the pricing information for each of the one or more itineraries based at least on a determination of the second input.
